(19) United States
(12) Patent Application Publication
(10) Pub. No.: US 2010/0169166 A1
(43) Pub. Date: Jul. 1, 2010

(54) DATA QUALITY TESTS FOR USE IN A CAUSAL PRODUCT DEMAND FORECASTING SYSTEM

(76) Inventors: Arash Bateni, Toronto (CA); Edward Kim, Toronto (CA); Philippe Hamel, Laval (CA); Blazimir Radovic, Toronto (CA)

Correspondence Address: JAMES M. STOVER;TERADATA CORPORATION, 2835 MIAMI VILLAGE DRIVE, MIAMISBURG, OH, 45342, US

(21) Appl. No.: 12/649,005

(22) Filed: Dec. 29, 2009

Related U.S. Application Data
(60) Provisional application No. 61/142,011, filed on Dec. 31, 2008.

(51) Int. Cl. G06Q 10/00; G06F 17/30

(52) U.S. Cl. 705/10; 707/802; 707/E17.044

(57) ABSTRACT

An improved method for forecasting and modeling product demand for a product. The forecasting methodology employs a causal methodology, based on multiple regression techniques, to model the effects of various factors on product demand, and hence better forecast future patterns and trends, improving the efficiency and reliability of the inventory management systems. The improved method identifies linear dependent causal factors and removes redundant causal factors from the regression analysis. A product demand forecast is generated by blending forecast or expected values of the non-redundant causal factors together with corresponding regression coefficients determined through the analysis of historical product demand and factor information.

### CROSS REFERENCE TO RELATED APPLICATIONS

This application claims priority under 35 U.S.C. § 119(e) to the following co-pending and commonly-assigned patent application, which is incorporated herein by reference:

Provisional Patent Application Ser. No. 61/142,011, entitled “DATA QUALITY TESTS FOR USE IN A CAUSAL PRODUCT DEMAND FORECASTING SYSTEM” by Arash Bateni, Edward Kim, Philippe Dupuis Hamel, and Blazimir Radovic; filed on Dec. 31, 2008.

This application is related to the following co-pending and commonly-assigned patent applications, which are incorporated by reference herein:

Application Ser. No. 11/613,404, entitled “IMPROVED METHODS AND SYSTEMS FOR FORECASTING PRODUCT DEMAND USING A CAUSAL METHODOLOGY,” filed on Dec. 20, 2006, by Arash Bateni, Edward Kim, Philip Liew, and J. P. Vorsanger;

Application Ser. No. 11/938,812, entitled “IMPROVED METHODS AND SYSTEMS FOR FORECASTING PRODUCT DEMAND DURING PROMOTIONAL EVENTS USING A CAUSAL METHODOLOGY,” filed on Nov. 13, 2007, by Arash Bateni, Edward Kim, Harmintar Atwal, and J. P. Vorsanger; and

Application Ser. No. 11/967,645, entitled “TECHNIQUES FOR CAUSAL DEMAND FORECASTING,” filed on Dec. 31, 2007, by Arash Bateni, Edward Kim, J. P. Vorsanger, and Rong Zong.

### FIELD OF THE INVENTION

The present invention relates to a methods and systems for forecasting product demand using a causal methodology, based on multiple regression techniques, for modeling the effects of various factors on product demand to forecast future product demand patterns and trends, and in particular to the performance of data quality tests to ensure prior to performing regression analysis.

### BACKGROUND OF THE INVENTION

Accurate demand forecasts are crucial to a retailer's business activities, particularly inventory control and replenishment, and hence significantly contribute to the productivity and profit of retail organizations.

Teradata Corporation has developed a suite of analytical applications for the retail business, referred to as Teradata Demand Chain Management (DCM), which provides retailers with the tools they need for product demand forecasting, planning and replenishment. Teradata Demand Chain Management assists retailers in accurately forecasting product sales at the store/SKU (Stock Keeping

Unit) level to ensure high customer service levels are met, and inventory stock at the store level is optimized and automatically replenished. Teradata DCM helps retailers anticipate increased demand for products and plan for customer promotions by providing the tools to do effective product forecasting through a responsive supply chain.

In application Ser. Nos. 11/613,404; 11/938,812; and 11/967,645, referred to above in the CROSS REFERENCE TO RELATED APPLICATIONS, Teradata Corporation has presented improvements to the DCM Application Suite for forecasting and modeling product demand during promotional and non-promotional periods. The forecasting methodologies described in these references seek to establish a cause-effect relationship between product demand and factors influencing product demand in a market environment. Such factors may include current product sales rates, seasonality of demand, product price changes, promotional activities, weather forecasts, competitive information, and other factors. A product demand forecast is generated by blending the various influencing causal factors in accordance with corresponding regression coefficients determined through the analysis of historical product demand and factor information. Described below is a method for identifying linear dependent causal variables within a data sample from which the regression coefficients are determined, and removing redundant causal variables from the regression analysis.

### BRIEF DESCRIPTION OF THE DRAWINGS

FIG. 1 is a flow diagram illustrating a method for determining product demand forecasts utilizing a causal methodology.

FIG. 2 is a diagram illustrating a method for identifying linear dependent causal variables within a data sample, and removing redundant causal variables from regression analysis in accordance with the preset invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

As stated above, the causal demand forecasting methodology seeks to establish a cause-effect relationship between product demand and factors influencing product demand in a market environment. A product demand forecast is generated by blending the various influencing factors in accordance with corresponding regression coefficients determined through the analysis of historical product demand and factor information. The multivariable regression equation can be expressed as:

y=b₀+b₁x₁+b₂x₂+ . . . +bₖxₖ (EQN 1);

where y represents demand; x₁ through xₖ represent causal variables, such as current product sales rate, seasonality of demand, product price, promotional activities, and other factors; and b₀ through bₖ represent regression coefficients determined through regression analysis using historical sales, price, promotion, and other causal data.

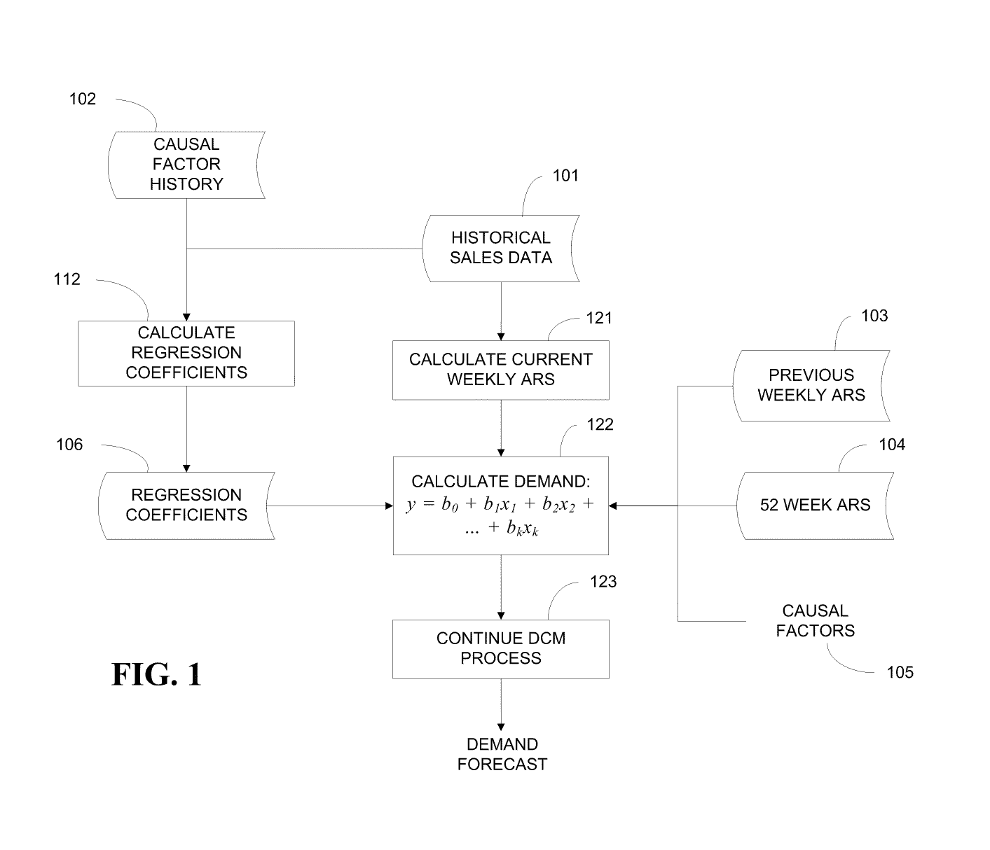

FIG. 1 is a flow chart illustrating a casual method for estimating product demand at weekly intervals. As part of the DCM demand forecasting process, historical demand data 101 is saved for each product or service offered by a retailer. The DCM system also determines and saves previous weekly Average Rate of Sale (ARS) and 52-week ARS data, 103 and 104, respectively; and price, promotional and other causal factor history 102.

In step 112, regression coefficients (b₀ through bₖ) are calculated using historical sales data 101 and causal factor historical information 102. Results are saved as data 106. This calculation may be run weekly to update the coefficients as new sales data becomes available.

In step 121 of FIG. 1, the current weekly ARS for a product is calculated from historical demand data 101. In step 122, the product demand forecast is determined by blending the Average Rate of Sale (ARS) from step 121 with the previous and 52^{nd} lags of the weekly demand from data stores 103 and 104, respectively, and other causal factor data 105. The current ARS (x₁), previous weekly ARS (x₂), 52-week ARS (x₃), and other causal factors (x₄ through xₖ) are blended in accordance with EQN1, with the regression coefficients (b₀ through bₖ) calculated in step 311. Although separate data stores are indicated by reference numerals 101 through 106, the stored data may be saved in a single storage device or database.

At step 123, the DCM forecasting process continues to generate and provide demand forecasts, product order suggestions, and other information of interest to a retailer.

Regression coefficients calculation (step 112) is performed using an aggregate user-defined function (UDF), and creation of the output table 106, is done through a tabular UDF. The role of the aggregate UDF is to calculate regression coefficients using, as input, a table containing the historical variations of demand 101 and that of various other causal variables 102. During regression analysis temporary matrices are created and used in the calculation of regression coefficients. Performing data quality tests on the data samples used in regression calculations are essential to ensure the quality of the regression equation and performance of the aggregate UDF. It is important that any data that leads to matrix singularity be detected and disregarded before the regression calculations take place. Such data cannot be analyzed by regression. Specifically, data quality tests involve the detection of:
Test1: Variables that remain unchanged throughout the history
Test2: Variables that are dependent or redundant with respect to each other
Test3: Insufficient history (as a rule of thumb, the number of rows of history must be more than 10 times the number of regression variables).

Tests that detect the first and last cases are easily implemented. However, the development of a test to detect dependent and redundant variables is more complex. This is because aggregate UDFs are limited to read only one row of an input matrix at a time, and existing methods to detect linear dependencies in a matrix require the manipulation the entire matrix.

Presented herein is a novel method to detect linear dependency between causal variables, when only one row of data is available at a time. Such linear relationship can be described as a.v₁+b=v₂, where a and b are parameters, and v₁ and v₂ are two vectors (causal variables). If this relation—with the same parameters a and b—satisfies all of the rows of variables v1 and v2, then variables v1 and v2 are dependent and one of the variables should be removed from the regression analysis.

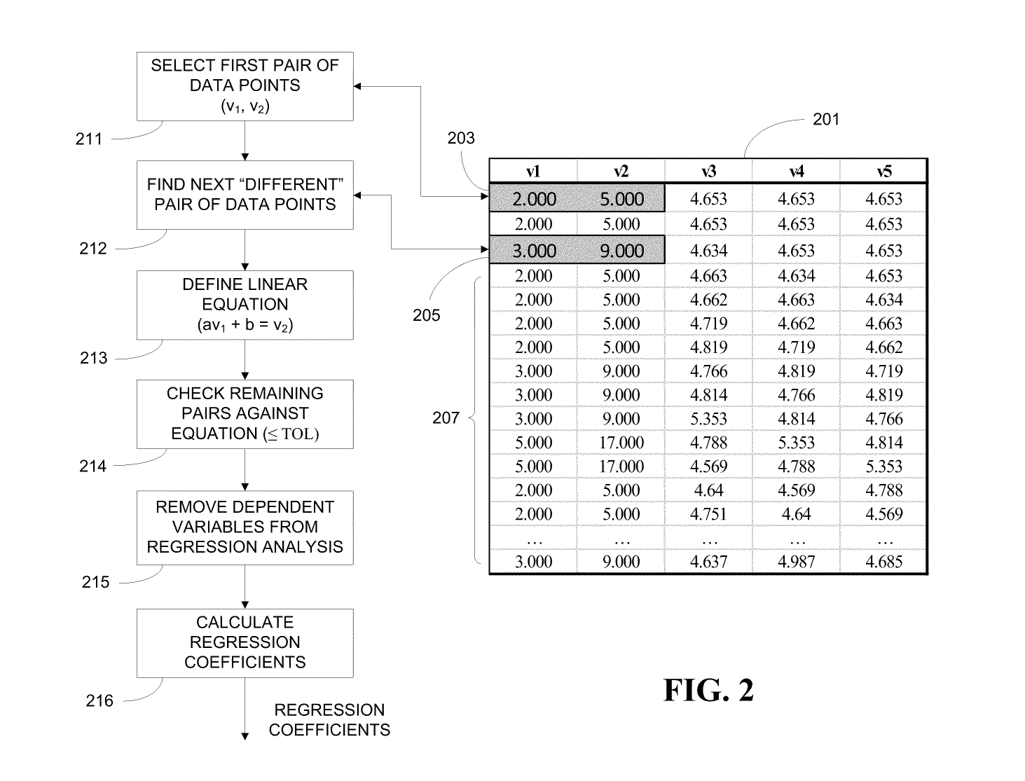

The flow diagram shown in FIG. 2 illustrates a method for identifying linear dependent causal variables within a data sample, and removing redundant causal variables from regression analysis in accordance with the preset invention. The data sample is represented by table 201 of FIG. 2, where each column of table 201 represents a causal variable, v₁ through v₅, and each row represents measured values for the causal variables vᵢ over different weeks of history.

The dependency test is performed on each pair of causal variables. For example, the dependency of (v1, v2), (v1, v3), (v2, v3), etc. should be tested. The following describes the method for testing the dependency of (v1, v2). The same algorithm is applied to all pairs of variables.

After the pair of variables is selected, e.g., v1 and v2, the following steps are performed:

Step 211: A first pair 203 of available data points is selected and stored. Pair 203 consists of the values (2.000, 5.000) contained in the first row of table 201.

Step 212: The next “different” pair 205 is identified. In the example provided in FIG. 2, pair 205 consists of the values (3.000, 9.000) contained in the third row of table 201. Note that the second row of table 201 does not have data different from the first row, so it is skipped.

Step 213: Two liner equations a.v₁+b =v₂ are formed from the two pairs (pairs 203 and 205) of data selected in steps 211 and 212. This system of equations is then solved for parameters a and b. In the example illustrated, it would be found that a=4 and b=−3.

Step 214: The remaining rows 207 of table 201 are checked to determine if parameter values a and b, calculated in step 213, hold for the rest of the variable pairs (v₁, v₂). If the relationship holds for all remaining rows, or pairs, then v₁ and v₂ are determined to be linearly dependent. Conversely, it will be concluded that there is no linear relationship as soon as a causal variable pair is found that does not satisfy the equation.

The remaining rows of table 201 are checked by substituting the values of each subsequent “different” pair of values in the equation a.v₁+b=v₂ to verify if this relationship holds true for all pairs. In this example, the next pair to substitute in would be (5.000, 17.000) in row 11. As all pairs (v₁, v₂) satisfy the linear equation a.v₁+b=v₂, where a=4 and b=−3, v₁ and v₂ are found to be linearly dependent and one should be removed from the regression calculation.

As mentioned above, the method performs the dependency tests on all pair-wise combination of variables. These tests are done simultaneously since only one row of data is read and is available at a time.

Dependent causal variables are removed from the regression analysis in step 215, and regression coefficients are calculated in step 216.

As some variation in the values of causal variables is to be expected even with dependent variables, such as from round-off errors, a certain tolerance (TOL) is required when checking the validity of the linear relationship with different causal variable pairs. For the relationship a.v₁+b=v₂, a tolerance calculation can be performed by first calculating the value v₂′ of the left hand side, a.v₁+b, of the relationship, and comparing v₂′ with the actual value of v₂. If v₂′=v₂ then the relationship holds. However, when the values are not exact, the percentage difference of the two values v₂′ and v₂ is determined and if the values v₂′ and v₂ are close enough, e.g., the difference is less than an acceptable tolerance, it is assumed that the relationship still holds. This test of tolerance can be expressed by the equation (v₂′−v₂)/v₂≦TOL.

### Conclusion

The Figures and description of the invention provided above reveal a method for identifying linear dependent causal variables within a data sample from which the regression coefficients are determined, and removing redundant causal variables from the regression analysis.

Although the invention as described above is utilized within a demand forecasting system, other data analysis applications may benefit from inclusion or use of the methodology described herein.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching.

What is claimed is:

1. A computer-implemented method for forecasting product demand for a product, the method comprising the steps of:
maintaining, on a computer, an electronic database of historical product demand information and historical causal factor information for a plurality of factors influencing demand for said product;
analyzing, by said computer, said causal factor information to identify non-redundant causal factors;
analyzing, by said computer, said historical product demand information and said historical causal factor information for said product to determine a plurality of regression coefficients corresponding to said non-redundant causal factors; and
blending, by said computer, said plurality of regression coefficients and future values for said corresponding non-redundant causal factors to determine a product demand forecast for said product;.

2. The computer-implemented method for forecasting product demand for a product in accordance with claim 1, wherein said step of analyzing said causal factor information to identify non-redundant causal factors comprises:
selecting a first and second causal factors for examination;
comparing historical values for said first causal factor with historical values of said second causal factor to identify a linear relationship between the historical values of said first and second causal factors;
identifying said first causal factor as a non-redundant causal factor and said second causal factor as a redundant causal factor when a linear relationship is identified between the historical values of said first and second causal factors; and
Teradata Corporation Docket No. 20170 identifying said first causal factor as a non-redundant causal factor and said second causal factor as a non-redundant causal factor when a linear relationship is not identified between the historical values of said first and second causal factors.

3. The computer-implemented method for forecasting product demand for a product in accordance with claim 2, wherein a linear relationship between the historical values of said first and second causal factors is established when the historical values of said first and second causal factors values are within a predetermined tolerance to a linear equation.

4. A system for forecasting product demand for a product, comprising:
an electronic database containing historical product demand information and historical causal factor information for a plurality of factors influencing demand for said product;
a computer including a product forecasting application for:
analyzing said causal factor information to identify non-redundant causal factors;
analyzing said historical product demand information and said historical causal factor information for said product to determine a plurality of regression coefficients corresponding to said non-redundant causal factors; and
blending said plurality of regression coefficients and future values for said corresponding non-redundant causal factors to determine a product demand forecast for said product;.

5. The system for forecasting product demand for a product according to claim 3, wherein said product forecasting application identifies non-redundant causal factors by:
selecting a first and second causal factors for examination;
comparing historical values for said first causal factor with historical values of said second causal factor to identify a linear relationship between the historical values of said first and second causal factors;
identifying said first causal factor as a non-redundant causal factor and said second causal factor as a redundant causal factor when a linear relationship is identified between the historical values of said first and second causal factors; and
identifying said first causal factor as a non-redundant causal factor and said second causal factor as a non-redundant causal factor when a linear relationship is not identified between the historical values of said first and second causal factors.

6. The computer-implemented method for forecasting product demand for a product in accordance with claim 5, wherein a linear relationship between the historical values of said first and second causal factors is established when the historical values of said first and second causal factors values are within a predetermined tolerance to a linear equation.
